(19) United States
(12) Patent Application Publication
(10) Pub. No.: US 2023/0155520 A1
(43) Pub. Date: May 18, 2023

(54) POWER CONVERSION DEVICE

(71) Applicants: KABUSHIKI KAISHA TOSHIBA, Tokyo (JP); Toshiba Energy Systems & Solutions Corporation, Kawasaki-shi Kanagawa (JP)

(72) Inventors: Yukina AKIYAMA, Kawasaki Kanagawa (JP); Koji TOBA, Tama Tokyo (JP); Shunsuke KAWACHI, Tama Tokyo (JP); Yuki KUDO, Fuchu Tokyo (JP); Takahiro KASE, Kawasaki Kanagawa (JP)

(73) Assignees: KABUSHIKI KAISHA TOSHIBA, Tokyo (JP); Toshiba Energy Systems & Solutions Corporation, Kawasaki-shi Kanagawa (JP)

(21) Appl. No.: 17/905,160

(22) PCT Filed: Jan. 7, 2021
(86) PCT No.: PCT/JP2021/000365

§ 371 Date: Aug. 26, 2022

(30) Foreign Application Priority Data
Apr. 6, 2020 (JP) 2020-068106

(51) Int. Cl. H02M 7/525; H02J 3/08; H02J 3/38; H02J 9/06

(52) U.S. Cl. CPC H02M 7/525; H02J 3/08; H02J 3/381; H02J 9/062; H02J 2300/28

(57) ABSTRACT

Provide is a power conversion device capable of avoiding a power outage even if reference AC power is lost. A power conversion device 1 includes a phase detector 31 calculating a voltage phase based on the phase of AC power supplied to an electric power system 9, a waveform controller 35 generating a control signal designating the frequency and phase of the AC power based on the voltage phase calculated by the phase detector 31, a power conversion circuitry 12 which converts power supplied from a power supply source 15 into the AC power based on the control signal generated by the waveform controller 35, and which outputs the converted power to the electric power system 9, and a determination block 44 which detects the frequency of the AC power supplied to the electric power system 9, and which determines that the AC power that becomes the reference for the frequency is not supplied to the electric power system 9 when the detected frequency is not within a preset first frequency range. When the determination block 44 determines that the AC power that becomes the reference for the frequency is not supplied to the electric power system 9, the waveform controller 35 executes a control on the power conversion circuitry 12 so as to supply the AC power that becomes the reference for the frequency to the electric power system 9.

### TECHNICAL FIELD

The embodiments relate to a power conversion device that converts power supplied from a power supply source into AC power.

### BACKGROUND ART

In recent years, renewable energy power sources, such as solar power generation and wind power generation, and batteries are utilized as power supply sources. DC power output by the renewable energy power sources and the batteries is converted into AC power by a power conversion device. The AC power converted by the power conversion device is supplied to an electric power system. Power conversion devices convert power based on the voltage, frequency and phase of the reference AC power in an electric power system, and output AC power. A power conversion device is known which controls the voltage, frequency and phase of the output power.

### CITATION LIST

### Patent Literatures

Patent Document 1: JP 2014-50292 A

### SUMMARY OF INVENTION

### Technical Problem

As described above, power conversion devices convert power based on the voltage, frequency and phase of the reference AC power in an electric power system, and output AC power. When an electric power system includes power generation facilities that utilize a rotating power generator, such as thermal power generation, hydroelectric power generation or nuclear power generation, a power conversion device converts power based on the voltage, frequency and phase of the AC power that is output by the rotating power generator as AC power utilized as a reference.

When the electric power system includes power-supply facilities only that utilize power conversion devices, such as a renewable energy power source and batteries like solar power generation or wind power generation, one power conversion device outputs reference AC power, and the other power conversion device converts power based on the voltage, frequency and phase of the reference AC power output by the one power conversion device.

It is desirable that a plurality of power conversion devices should output AC power with the consistent voltage, frequency and phase even if the reference AC power is lost due to an accident, etc.

In recent years, introduction of renewable energy power sources is promoted. A renewable energy power source like solar power generation or wind power generation is connected to an AC electric power system by a power conversion device like an inverter that utilizes a power-electronics technology. Such a power source is called an inverter-based power source. Moreover, a system like batteries installed in order to suppress the output fluctuation of renewable energy is also included as an inverter-based power source.

According to a small-scale electric power system called an off-grid system installed at an isolated island, etc., power may be supplied to a load only by inverter-based power sources not depending on a rotating power source in some cases. Moreover, according to conventional electric power systems in which synchronous power generators and inverter-based power sources are present in combination, a partial region may be disconnected due to a system accident, etc., and power may be supplied to a load by only the inverter-based power sources within the region called a microgrid.

In order to stably supply power only by inverter-based power sources, it is necessary to properly control a plurality of inverter-based power sources that shares the output, and to maintain the voltage, frequency and phase of an electric power system. A technology is known in which, among the plurality of inverter-based power sources, a control is executed on one inverter-based power source so as to output the reference AC power, and a control is executed on the other inverter-based power sources so as to output AC power based on the voltage, frequency and phase of the reference AC power. The operation mode of the inverter-based power source to output the reference AC power for power conversion is called a voltage-source mode. The operation mode of the inverter-based power source to output AC power based on the voltage, frequency and phase of the reference external AC power is called a grid-connected mode. The grid-connected mode may be also called a current-source mode.

When, however, the inverter-based power source that is operating in the voltage-source mode becomes unable to maintain the operation due to a malfunction, etc., the reference AC power is lost in the electric power system. The voltage, frequency, and phase of the reference AC power are lost, and thus the other inverter-based power sources that are operating in the grid-connected mode become unable to maintain the operation. Consequently, the electric power system results in a power outage.

When the reference AC power is lost, instead of the inverter-based power source that was operating in the voltage-source mode, one of the other inverter-based power sources that are operating in the grid-connected mode is selected, and is caused to operate in the voltage-source mode. However, in order to cause one of the other inverter-based power sources to operate in the voltage-source mode, it is necessary to once deactivate such inverter-based power source and to reset to the voltage-source mode. In order to once deactivate the inverter-based power source, there is a technical problem such that a temporal power outage occurs in the electric power system.

An objective of the embodiments is to provide a power conversion device capable of avoiding a power outage even if reference AC power is lost.

### Solution to Problem

A power conversion device according to the embodiments of the present disclosure includes the following features;
(1) a phase detector that calculates a voltage phase based on a phase of AC power supplied to an electric power system;
(2) a waveform controller that generates a control signal which designates a frequency of the AC power and a phase thereof based on the voltage phase calculated by the phase detector;
(3) a power conversion circuitry which converts power supplied from a power supply source into the AC power based on the control signal generated by the waveform controller, and which outputs the converted power to the electric power system; and
(4) a determination block which detects the frequency of the AC power supplied to the electric power system, and which determines that the AC power that becomes a reference for the frequency is not supplied to the electric power system when the detected frequency is not within a preset first frequency range.
(5) When the determination block determines that the AC power that becomes the reference for the frequency is not supplied to the electric power system, the waveform controller executes a control on the power conversion circuitry so as to supply the AC power that becomes the reference for the frequency to the electric power system.

### BRIEF DESCRIPTION OF DRAWINGS

FIG. 1 is a diagram illustrating a configuration of a power conversion system according to a first embodiment;

FIG. 2 is a diagram illustrating a structure of a power conversion device according to the first embodiment;

FIG. 3 is a diagram illustrating a structure of an output-voltage control unit of the power conversion device according to the first embodiment;

FIG. 4 is a diagram illustrating control blocks of a phase detector of the power conversion device according to the first embodiment;

FIG. 5 is a diagram illustrating a structure of a waveform controller of the power conversion device according to the first embodiment;

FIG. 6 is a diagram illustrating a time relating to an operation of the power conversion device when one power conversion device stops supplying power;

FIG. 7 is a diagram illustrating a time relating to an operation of the power conversion device when two power conversion devices stop supplying power;

FIG. 8 is a diagram illustrating a structure of a modified example of the waveform controller of the power conversion device according to the first embodiment;

FIG. 9 is a diagram for describing a structure of a power conversion device according to a second embodiment;

FIG. 10 is a diagram illustrating a structure of a modified example of a waveform controller of the power conversion device according to the second embodiment; and

FIG. 11 is a diagram illustrating a structure of another modified example of the waveform controller of the power conversion device according to the second embodiment.

### DESCRIPTION OF EMBODIMENTS

A power conversion device 1 and a power conversion system 100 according to an embodiment of the present disclosure will be described below with reference to the figures. Note that the embodiments to be described below are merely examples, and the present disclosure should not be interpreted with limitations to such embodiments. In the embodiments, when there are plural devices and components that have the same structure, the same reference numeral will be given to those for description, and when each of the devices and components that have the same structure will be individually described, an alphabetical (small letter) suffix is given to the common reference numeral for the purpose of distinction.

(1. First Embodiment)

(1-1. Structure)

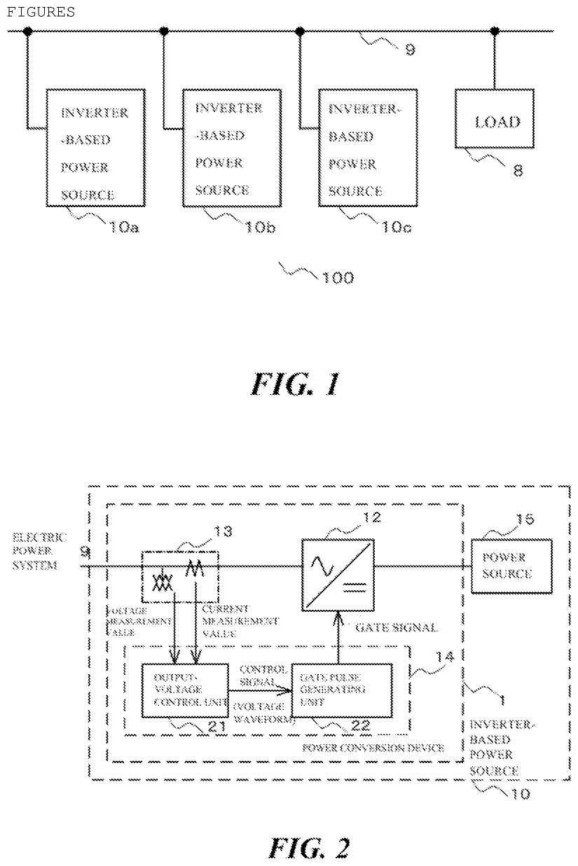

With reference to FIGS. 1 to 5, a structure of a power conversion device 1 and a configuration of a power conversion system 100 will be described as examples of this embodiment. The power conversion system 100 includes a plurality of inverter-based power sources 10, and supplies power to a load 8 through an electric power system 9. As an example, the power conversion system 100 includes three inverter-based power sources 10a, 10b and 10c. The power conversion system 100 may include an arbitrary number of the inverter-based power sources 10a to 10n. Moreover, the power conversion system 100 may be connected to power generation facilities, such as thermal power generation, hydroelectric power generation, and nuclear power generation.

In FIG. 1, although the electric power system 9 is illustrated as including the single load 8, the electric power system 9 may include a plurality of loads 8.

Moreover, when, for example, the voltage of the inverter-based power source 10 and the voltage of the electric power system 9 are inconsistent, the inverter-based power source 10 may be connected to the electric power system 9 through a transformer (unillustrated in the figure).

(Inverter-Based Power Source 10)

FIG. 2 illustrates a structure of the inverter-based power source 10. The inverter-based power source 10 includes the power conversion device 1 and a power source 15. The inverter-based power sources 10a, 10b and 10c employ the same structure.

The power source 15 includes a renewable energy power source, such as a solar power generation facility or a wind power generation facility. The power source 15 generates DC power, and supplies such power to the power conversion device 1. Moreover, the power source 15 may include batteries. When the power source 15 includes the batteries, the AC power from the electric power system 1 is converted into DC power by the power conversion device 1, and the power source 15 is charged. The power source 15 that is batteries outputs DC power, and supplies such power to the power conversion device 1.

(Power Conversion Device 1)

The power conversion device 1 is connected to the electric power system 9 and to the power source 15. The power conversion device 1 converts the DC power output by the power source 15 into AC power, and supplies such power to the electric power system 9. The power conversion device 1 includes a power conversion circuitry 12, a voltage and current measuring circuitry 13, and a control circuitry 14. The power conversion device 1 may include an interconnection reactor and a harmonic filter between the power conversion circuitry 12 and the electric power system 9.

The power conversion circuitry 12 includes semiconductor switches like field-effect transistors (FETs). The power conversion circuitry 12 is connected to the power source 15 and to the electric power system 9. The power conversion circuitry 12 is controlled by the control circuitry 14. The power conversion circuitry 12 converts DC power output by the power source 15 into AC power, and supplies such power to the electric power system 9. When the power source 15 includes batteries, the power conversion circuitry 12 converts the AC power of the electric power system 9 into DC power, and supplies such power to the power source 15. The power source 15 stores DC power converted by the power conversion circuitry 12.

The voltage and current measuring circuitry 13 includes a measuring transformer, and a measuring rectifier, etc. The voltage and current measuring circuitry 13 is placed at an interconnection point between the power conversion circuitry 12 and the electric power system 9, and is connected to the control circuitry 14. The voltage and current measuring circuitry 13 measures the voltage and the current at the interconnection point between the power conversion device 1 and the electric power system 9. The amplitude, frequency and phase of the voltage are measured by the voltage and current measuring circuitry 13 and are taken as a voltage measurement value, and the amplitude, frequency and phase of the current are measured and are taken as a current measurement value. The voltage and current measuring circuitry 13 outputs the voltage measurement value and the current measurement value to the control circuitry 14. When the power conversion device 1 includes a harmonic filter between the power conversion circuitry 12 and the electric power system 9, the voltage and current measuring circuitry 13 measures the current at both the electric-power-system-9 side of the harmonic filter and the power conversion circuitry 12 side thereof, and outputs such measurement values to the control circuitry 14.

The control circuitry 14 includes a hardware circuit, or a microcomputer, etc. The control circuitry 14 controls the power conversion circuitry 12 based on the measurement value from the voltage and current measuring circuitry 13. The control circuitry 14 includes the output-voltage control unit 21 and a gate pulse generating unit 22.

The output-voltage control unit 21 is connected to the voltage and current measuring circuitry 13 and to the gate pulse generating unit 22. Based on the measurement value from the voltage and current measuring circuitry 13, the output-voltage control unit 21 generates a control signal, and outputs such a signal to the gate pulse generating unit 22. The control signal is a signal that controls the gate pulse generating unit 22, and is a voltage waveform of a sine wave. The amplitude, frequency and phase of the voltage are to be designated by the control signal. The control signal may designate, by telegram message, the amplitude, frequency and phase of the voltage. The detailed the structure of the output-voltage control unit 21 will be described later.

The gate pulse generating unit 22 is connected to the output-voltage control unit 21 and to the power conversion circuitry 12. Based on the amplitude, frequency and phase of the voltage according to the control signal received from the output-voltage control unit 21, the gate pulse generating unit 22 generates a gate signal, and outputs such a signal to the power conversion circuitry 12. The gate signal is a signal that modulates the output voltage waveform of the power conversion circuitry 12, and is, for example, a pulse width modulation (PWM modulation) signal that controls the ON and OFF states of the semiconductor switch in the power conversion circuitry 12. In accordance with the amplitude, frequency and phase of the voltage which are controlled by the gate pulse generating unit 22, the power conversion circuitry 12 converts the DC power output by the power source 15 into

AC power, and supplies such power to the electric power system 9.

(Structure of Output-voltage Control Unit 21)

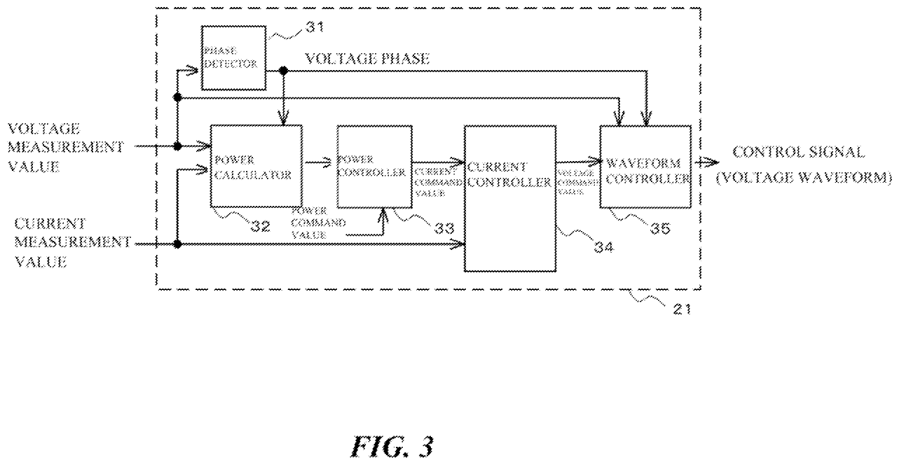

FIG. 3 illustrates a structure of the output-voltage control unit 21. The output-voltage control unit 21 includes a hardware circuit or a microcomputer, etc.

The output-voltage control unit 21 includes a phase detector 31, a power calculator 32, a power controller 33, a current controller 34, and a waveform controller 35.

The phase detector 31 is connected to the voltage and current measuring circuitry 13, the power calculator 32, and the waveform controller 35. The phase detector 31 calculates and outputs a voltage phase based on the voltage measurement value output by the voltage and current measuring circuitry 13. The detailed structure of the phase detector 31 will be described later.

The power calculator 32 is connected to the voltage and current measuring circuitry 13 and to the power controller 33. The power calculator 32 calculates, based on the voltage measurement value and the current measurement value both output by the voltage and current measuring circuitry 13, and on the voltage phase output by the phase detector 31, the effective power value and the reactive power value both to be output by the power conversion circuitry 12, and outputs the calculated values to the power controller 33.

The power controller 33 is connected to the power calculator 32 and to the current controller 34. The power controller 33 calculates, based on the power command value input from an external device and on the effective power value and the reactive power value both calculated by the power calculator 32, a current command value to be output by the power conversion circuitry 12. The current command value is set to be a command value in such a way that the effective power and the reactive power both output by the power conversion circuitry 12 follow the desired power values. The power controller 33 outputs the calculated current command value to the current controller 34.

The power command value is a command value that designates the effective power and the reactive power both to be output by the power conversion device 1. The power command value may be a command value input to the power controller 33 from an external device like a power supply-and-demand control device (unillustrated in the figure), or may be a preset command value. The power command value may have a value that changes over time, or may be a fixed value.

The current controller 34 is connected to the voltage and current measuring circuitry 13, the power controller 33, and the waveform controller 35. The current controller 34 calculates, based on the current measurement value output by the voltage and current measuring circuitry 13 and on the current command value calculated by the power controller 33, a voltage command value. The voltage command value is a command value in such a way that the effective power and the reactive power both to be output by the power conversion circuitry 12 follow the desired power value. The current controller 34 outputs the calculated voltage command value to the waveform controller 35.

The waveform controller 35 is connected to the phase detector 31, the current controller 34, and the gate pulse generating unit 22. Based on the voltage measurement value output by the voltage and current measuring circuitry 13, on the voltage phase output by the phase detector 31 and on the voltage command value calculated by the current controller 34, the waveform controller 35 generates a control signal, and outputs such a signal to the gate pulse generating unit 22. The control signal is a signal that controls the gate pulse generating unit 22, and is a voltage waveform of sine wave. The amplitude, frequency and phase of the voltage are designated by the control signal. The control signal may designate the amplitude, frequency and phase of the voltage by telegram message.

The gate pulse generating unit 22 controls the power conversion circuitry 12 based on the control signal output by the waveform controller 35. The power conversion circuitry 12 converts the DC power output by the power source 15 into the AC power with the voltage that has the designated amplitude, frequency and phase, and supplies such power to the electric power system 9.

(Structure of Phase Detector 31)

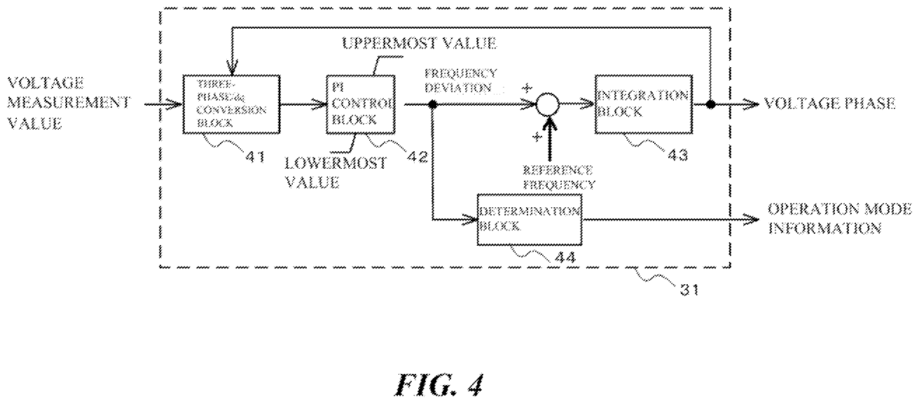

A structure of the phase detector 31 will be described. The phase detector 31 includes a hardware circuit, or a microcomputer, etc. The phase detector 31 includes control blocks illustrated in FIG. 4.

The phase detector 31 includes the control blocks that are a three-phase/dq conversion block 41, a PI control block 42, an integration block 43, and a determination block 44.

The three-phase/dq conversion block 41 converts, based on the voltage measurement value output by the voltage and current measuring circuitry 13, the voltage measurement value into a dq-axis voltage value. The PI control block 42 executes a control in such a way that the voltage value at a reference axis among the dq axes becomes zero based on the dq-axis voltage value converted by the three-phase/dq conversion block 41. Moreover, the PI control block 42 includes a limiter that limits the frequency up to the lowermost frequency and to the uppermost frequency. The values according to the lowermost frequency and to the uppermost frequency are set to be predetermined values by an external device (unillustrated in the figure).

The integration block 43 calculates the phase from the total value of frequency deviation output by the PI control block 42 and a reference frequency (e.g., a commercial frequency that is 50 Hz or 60 Hz). The determination block 44 detects the frequency output by the PI control block 42. Moreover, the determination block 44 selects an operation mode based on the frequency deviation output by the PI control block 42. As such an operation mode, either one of a voltage-source mode or a grid-connected mode is selected. The voltage-source mode is the mode of outputting the reference AC power for power conversion. The grid-connected mode is the mode of outputting the AC power based on the voltage, frequency and phase of the external reference AC power. The grid-connected mode is also referred to as a current-source mode in some cases.

The PI control block 42 includes a limiter that limits the frequency up to the lowermost frequency and to the uppermost frequency. When the reference AC power for power conversion is lost, the frequency according to the power output by the power conversion circuitry 12 is limited to the lowermost frequency or to the uppermost frequency set by the PI control block 42. Accordingly, the waveform controller 35 limits the frequency within the preset frequency range to generate the control signal.

The value of the lowermost frequency and that of the uppermost frequency are set for each power conversion device 1 that forms the inverter-based power source 10a, 10b or 10c. The value of the lowermost frequency and that of the uppermost frequency are decided based on the preference order of the inverter-based power sources 10a, 10b and 10c, one of which suppling the reference AC power for the frequency to the electric power system 9 when the reference AC power for the power conversion is lost.

When the reference AC power for power conversion is lost, the power conversion device 1 connected to the firstly preferential inverter-based power source 10 that outputs the reference AC power is set to the values of the lowermost frequency and the uppermost frequency according to a first substitution mode, and the power conversion device 1 connected to the secondary preferential inverter-based power source 10 that outputs the reference AC power is set to the values of the lowermost frequency and the uppermost frequency according to a second substitution mode.

The value of the lowermost frequency according to the first substitution mode is greater than the value of the lowermost frequency according to the second substitution mode. The value of the uppermost frequency according to the first substitution mode is smaller than the value of the uppermost frequency according to the second substitution mode. The ranges of the lowermost frequency and of the uppermost frequency according to the first substitution mode are narrower than the ranges of the lowermost frequency and the uppermost frequency according to the second substitution mode.

For example, the values of the lowermost frequency and of the uppermost frequency according to the first substitution mode are set to be ±3% relative to a reference frequency f0, and the values of the lowermost frequency and o the uppermost frequency according to the second substitution mode are set to be ±5% relative to the reference frequency f0. Note that the absolute value of the value of the lowermost frequency and that of the uppermost frequency may be inconsistent. For example, the value of the lowermost frequency according to the first substitution mode may be f0 −3%, and the value of the uppermost frequency may be f0 +2%.

Moreover, when there are equal to or greater than three inverter-based power sources 10 that are to output the reference AC power, equal to or greater than three power conversion devices 1 respectively connected to those inverter-based power sources 10 may be set to the first substitution mode, the second substitution mode, and the third substitution mode, etc., in sequence in which the ranges of the lowermost frequency and of the uppermost frequency become wide in accordance with the preferential sequence to output the reference AC power.

The PI control block 42 updates the set values of the lowermost frequency and the uppermost frequency to the value of the frequency f0 according to the reference AC power when a preset time has elapsed after the output of the reference AC power starts. For example, when the predetermined time has elapsed after the determination block 44 of the output-voltage control unit 21 of the control circuitry 14 determines that the inverter-based power source 10 starts outputting the reference AC power, the values of the lowermost frequency and the uppermost frequency are updated from ±3% to 0% relative to the reference frequency f0. The change rate according to this update may be constant or may follow a first-order lag characteristic, etc.

The output value of the PI control block 42 corresponds to a frequency deviation Δf from the reference frequency f0 of the voltage measurement value. That is, when the frequency fm (the frequency of the electric power system 9) of the voltage measurement value increases, the output value of the PI control block 42 increases, and when the frequency fm (the frequency of the electric power system 9) of the voltage measurement value decreases, the output value of the PI control block 42 decreases.

The determination block 44 determines that the AC power which is the reference for the frequency is not supplied to the electric power system 9 when the output value of the PI control block 42 is not within a preset frequency range f0±Δf1. For example, the determination block 44 determines that the AC power which is the reference for the frequency is not supplied to the electric power system 9 based on the fact that the output value of the PI control block 42 reaches the value of the lowermost frequency f0-Δf1 or that of the uppermost frequency f0+Δf1. Moreover, based on the fact that the output value of the PI control block 42 reaches the value of the lowermost frequency f0-Δf1 or that of the uppermost frequency f0+Δf1, the determination block 44 outputs operation mode information that causes the power conversion device 1 to transition to the voltage-source mode from the grid-connected mode, and causes the power conversion circuitry 12 to start outputting the reference AC power.

Based on the detection that the output value of the PI control block 42 is continuously being the value of the lowermost frequency f0-Δf1 or that of the uppermost frequency f0+Δf1 for a predetermined time period, and the output value of the PI control block 42 becomes the value of the lowermost frequency f0-Δf1 or that of the uppermost frequency f0+Δf1 by a predetermined number of times for the predetermined time period, the determination block 44 may further precisely detect that the AC power that becomes the reference for the frequency is not supplied. The determination block 44 outputs the operation mode information indicating that whether the power conversion device 1 should be operated by either one of the voltage-source mode or the grid-connected mode.

(Structure of Waveform Controller 35)

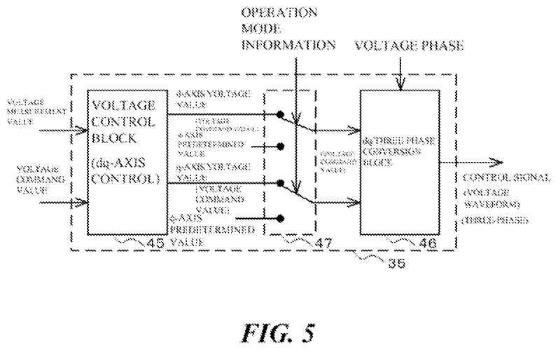

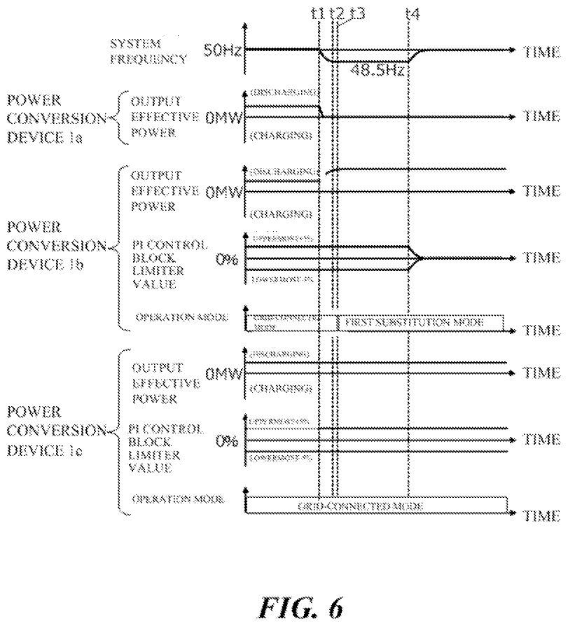

A structure of the waveform controller 35 will be described. The waveform controller 35 includes a hardware circuit, or a microcomputer, etc. The waveform controller 35 includes control blocks illustrated in FIG. 5.

The waveform controller 35 includes functional blocks that are a voltage control block 45, a dq/three-phase conversion block 46, and a selector block 47.

The voltage control block 45 is connected to the voltage and current measuring circuitry 13, the current controller 34, and the selector block 47. Based on the voltage measurement value output by the voltage and current measuring circuitry 13 and on the voltage command value calculated by the current controller 34, the voltage control block 45 calculates a d-axis voltage value and a q-axis voltage value as the new voltage command value, and outputs such value to the selector block 47. The d-axis voltage value is a control signal relating to the d-axis, and the q-axis voltage value is a control signal relating to the q-axis. The voltage control block 45 generates the control signal on the dq axis.

The selector block 47 is connected to the voltage control block 45, the dq/three-phase conversion block 46, and the determination block 44. Input to the selector block 47 are the d-axis voltage value output by the voltage control block 45, the q-axis voltage value, a d-axis predetermined value and a q-axis predetermined value both set in advance. The output by the selector block 47 is selected in accordance with the operation mode information output by the determination block 44. When the operation mode information indicates the grid-connected mode, the selector block 47 outputs, to the dq/three-phase conversion block 46, the d-axis voltage value and the q-axis voltage value both output by the voltage control block 45. When operation mode information indicates the voltage-source mode, the selector block 47 outputs, to the dq/three-phase conversion block 46, the d-axis predetermined value and the q-axis predetermined value.

The dq/three-phase conversion block 46 is connected to the selector block 47, the phase detector 31, and the gate pulse generating unit 22. When the operation mode information indicates the grid-connected mode, the dq/three-phase conversion block 46 outputs, to the gate pulse generating unit 22, the voltage waveform converted into three-phase based on the d-axis voltage value and the q-axis voltage value both calculated by the voltage control block 45, and on the voltage phase output by the phase detector 31.

When the operation mode information indicates the voltage-source mode, the dq/three-phase conversion block 46 outputs, to the gate pulse generating unit 22, the voltage waveform converted into three-phase based on the d-axis predetermined value, the q-axis predetermined value, and the voltage phase output by the phase detector 31.

The d-axis predetermined value and the q-axis predetermined value may be fixed values set for the d-axis and for the q-axis in advance, or may be variables that change over time. For example, the d-axis predetermined value may be set to the rated voltage value of the electric power system 1, and the q-axis predetermined value may be set to zero. The d-axis voltage value and the q-axis voltage value correspond to a first voltage command value in claims. The d-axis predetermined value and the q-axis predetermined value correspond to a second voltage command value in claims.

The above is the structure of the power conversion device 1 and the configuration of the power conversion system 100.

(1-2. Actions)

Next, with reference to FIGS. 1 to 7, the outline of the operation of the power conversion device 1 and that of the power conversion system 100 according to this embodiment will be described. The power conversion device 1 detects, by the determination block 44, the frequency fm of the AC power supplied to the electric power system 9.

The determination block 44 of the power conversion device 1 determines that the AC power that becomes the reference for the frequency is not supplied to the electric power system 9 when the detected frequency fm is not within a preset first frequency range f0±Δf1. When the determination block 44 determines that the AC power that becomes the reference for the frequency is not supplied to the electric power system 9, the waveform controller 35 executes a control on the power conversion circuitry 12 so as to supply the AC power that becomes the reference for the frequency to the electric power system 9.

The power conversion device 1 limits, by the phase detector 31, the frequency to a preset second frequency range f0±Δf2 and calculates the voltage phase. Δf1 and Δf2 may be the same value. The second frequency range f0±Δf2 is decided based on the preference order of the plurality of power supply sources 15, one of which supplying the AC power that becomes the reference for the frequency to the electric power system 9, and the second frequency range f0±Δf2 corresponding to the power supply source 15 with a high preference order is narrower than the second frequency range f0±Δf2 corresponding to the power supply source 15 with a low preference order.

When the AC power that becomes the reference for the frequency is not supplied to the electric power system 9, based on the preference order, one of the power conversion devices 1 which are operating in the grid-connected mode starts operating in the voltage-source mode, and supplies the AC power that becomes the reference for the frequency to the electric power system 9. Moreover, the other power conversion devices 1 that are operating in the grid-connected mode keep operating in the grid-connected mode.

With reference to FIG. 6, the detail of the operation of the power conversion device 1 and that of the power conversion system 100 will be described. As an example, the power conversion system 100 includes the three inverter-based power sources 10a, 10b and 10c. Power is supplied to the electric power system 9 by the three inverter-based power sources 10a, 10b and 10c. The inverter-based power sources 10a, 10b and 10c include the power conversion devices 1a, 1b and 1c, respectively.

It is assumed that, in the normal situation, the inverter-based power source 10a operates in the voltage-source mode, and the inverter-based power sources 10b and 10c operate in the grid-connected mode in a normal situation. The AC power that becomes the reference for the frequency is supplied to the electric power system 9 from the inverter-based power source 10a. When the AC power that becomes the reference for the frequency is not supplied to the electric power system 9 from the inverter-based power source 10a, the inverter-based power source 10b has the preference relative to the inverter-based power source 10c, and supplies the AC power that becomes the reference for the frequency to the electric power system 9.

The power conversion device 1b according to the inverter-based power source 10b is set to be in the first substitution mode. The power conversion device 1c according to the inverter-based power source 10c is set to be in the second substitution mode. The first substitution mode and the second substitution mode are decided based on the preference order of the power conversion device 1 that is to supply the AC power which is the reference for the frequency when the AC power that becomes the reference for the frequency is not supplied to the electric power system 9. For example, the preference order to supply the AC power that becomes the reference for the frequency is decided in accordance with a fact that, for example, the capacity of the inverter-based power source 10b is larger than the capacity of the inverter-based power source 10c, and the inverter-based power source 10 is set to be in the first substitution mode or the second substitution mode based on the preference order.

When the AC power that becomes the reference for the frequency is not supplied to the electric power system 9, and when equal to or greater than three power conversion devices 1 are provided, one of which suppling the AC power that becomes the reference for the frequency, the equal to or greater than three power conversion devices 1 may be set in the first substitution mode, the second substitution mode, and the third substitution mode, etc., in accordance with the preference order to output the reference AC power.

When the AC power that becomes the reference for the frequency is no longer supplied to the electric power system 9 from the inverter-based power source 10a, the AC power that becomes the reference for the frequency is then supplied from the power conversion device 1b that is set in the first substitution mode. When the AC power that becomes the reference for the frequency is no longer supplied to the electric power system 9 from the inverter-based power source 10b that includes the power conversion device 1b set in the first substitution mode, the AC power that becomes the reference for the frequency is supplied from the power conversion device 1c set in the second substitution mode.

The power conversion device 1b is set in the first substitution mode in advance. The PI control block 42 of the power conversion device 1b includes the limiter that limits the frequency to the lowermost frequency f0-Δf2b and to the uppermost frequency f0+Δf2b. The PI control block 42 of the power conversion device 1b set in the first substitution mode limits the frequency to the preset frequency range f0±Δf2b, and calculates the voltage phase. For example, the lowermost frequency f0-Δf2b of the PI control block 42 of the power conversion device 1b that is set in the first substitution mode is set to 50 Hz −3%, and the uppermost frequency f0+Δf2b is set to 50 Hz +3%.

The power conversion device 1c is set in the second substitution mode in advance. The PI control block 42 of the power conversion device 1c set in the second substitution mode limits the frequency to the preset frequency range f0±Δf2c, and calculates the voltage phase.

For example, the lowermost frequency f0-Δf2c of the PI control block 42 of the power conversion device 1c set in the second substitution mode is set to 50 Hz −5%, and the uppermost frequency f0+Δf2c is set to 50 Hz +5%.

The limiters of the respective PI control blocks 42 of the power conversion device 1b and the power conversion device 1c are set in advance so as to update to, for example, f0 ±0% after a predetermined time has elapsed when the determination block 44 determines that it is in the substitution mode.

Note that it is assumed that the commercial frequency f0 of the electric power system 1 is 50 Hz. Moreover, the d-axis predetermined value and the q-axis predetermined value selected by the selector blocks 47 in the respective waveform controllers 35 of the power conversion device 1b and the power conversion device 1c are set to the rated voltage value of the electric power system 1, and to be zero, respectively.

At the time t1 in a time chart illustrated in FIG. 6, when the AC power supply from the inverter-based power source 10a stops due to malfunction, etc., the AC power that becomes the reference for the frequency is no longer supplied, and thus a frequency fm of the electric power system 9 decreases. Hence, the output values of the respective PI control blocks 42 of the phase detectors 31 of the power conversion device 1b of the inverter-based power source 10b and of the power conversion device 1c of the inverter-based power source 10c decrease.

At the time t2, the output value of the PI control block 42 of the power conversion device 1b reaches the lowermost frequency f0-Δf2b. The lowermost frequency f0-Δf2b is, for example, 50 Hz −3% (48.5 Hz). The PI control block 42 of the power conversion device 1b limits the frequency to 48.5 Hz that is the preset frequency range f0±Δf2b, and calculates the voltage phase.

At the time t3, the determination block 44 of the power conversion device 1b detects, based on the voltage phase output by the PI control block 42, that the frequency fm of the AC power supplied to the electric power system 9 is out of the preset frequency range f0±Δf1b, and determines that the AC power that becomes the reference for the frequency is not supplied to the electric power system 9. For example, within the frequency range f0±Δf1b is 50 Hz ±3% (48.5 Hz).

Furthermore, based on the fact that the output value of the PI control block 42 reaches the lowermost frequency f0-Δf1b, the determination block 44 outputs the operation mode information in such a way that the power conversion device 1b transitions to the voltage-source mode from the grid-connected mode and the power conversion circuitry 12 starts outputting the reference AC power.

For example, the lowermost frequency f0-f1b is 50Hz −3% (48.5 Hz).

Based on the fact that the operation mode information output by the determination block 44 indicates the voltage-source mode, the selector block 47 outputs the d-axis predetermined value and the q-axis predetermined value to the dq/three-phase conversion block 46. The d-axis predetermined value is set to the rated voltage value of the electric power system 1, and the q-axis predetermined value is set to zero. Moreover, the voltage phase that is 48.5 Hz output by the phase detector 31 is input to the dq/three-phase conversion block 46.

The dq/three-phase conversion block 46 of the power conversion device 1b outputs, to the gate pulse generating unit 22, the voltage waveform converted into three-phase based on the d-axis predetermined value and the q-axis predetermined value output by the selector block 47, and on the voltage phase output by the phase detector 31. The voltage waveform converted into three-phase corresponds to the control signal.

Based on the voltage amplitude, frequency and phase according to the voltage waveform that is the control signal received from the output-voltage control unit 21, the gate pulse generating unit 22 of the power conversion device 1b generates the gate signal, and outputs such a signal to the power conversion circuitry 12. The gate signal is to modulate the output voltage waveform of the power conversion circuitry 12, and is, for example, a Pulse Width Modulation (PWM) signal that controls the ON and OFF states of the semiconductor switches in the power conversion circuitry 12. In accordance with the voltage amplitude, frequency and phase of the voltage controlled by the gate pulse generating unit 22, the power conversion circuitry 12 of the power conversion device 1b converts the DC power output by the power source 15 into the AC power, and supplies such power to the electric power system 9.

By the above-described operations, the power conversion device 1b of the inverter-based power source 10b starts, at the time t3, supplying the AC power that becomes the reference for the frequency to the electric power system 9. The amplitude of the AC power that becomes the reference for the frequency is the rated voltage value of the electric power system 9, and the frequency is 48.5 Hz.

Conversely, the power conversion device 1c of the inverter-based power source 10c keeps operating in the grid-connected mode. The AC power of 48.5 Hz that becomes the reference for the frequency is supplied to the electric power system 9 by the inverter-based power source 10b. The determination block 44 of the power conversion device 1c determines that the AC power that becomes the reference for the frequency is not supplied to the electric power system 9 when the frequency of the electric power system 9 is not within a frequency range f0±Δf1c. The frequency range f0±Δf1c is 50 Hz ±5% (from 47.5 Hz to 52.5 Hz).

The determination block 44 of the power conversion device 1c determines that the AC power that becomes the reference for the frequency is supplied to the electric power system 9 since the output value of the PI control block 42 has not reached the value of the lowermost frequency f0-Δf1c or that of the uppermost frequency f0+Δf1c, and the power conversion device 1c keeps operating in the grid-connected mode.

At the time t3, the power conversion device 1b of the inverter-based power source 10b starts supplying the AC power that becomes the reference for the frequency, and the AC power of the electric power system 9 becomes 48.5 Hz. At the time t4 after a preset time has elapsed from the time t3, the phase detector 31 of the power conversion device 1b updates the frequency range in the limiter of the PI control block 42 to the value of the frequency according to the reference AC power. The frequency range f0±Δf2b in the limiter of the PI control block 42 is updated to, for example, 50 Hz ±0% from 50 Hz ±3%.

Accordingly, the output value of the PI control block 42 of the inverter-based power source 10b changes in accordance with the lowermost limiter, and shifts to 50 Hz −0%. Consequently, the phase detector 31 outputs the voltage phase according to the reference frequency that is 50 Hz. Based on the voltage phase according to the reference frequency that is 50 Hz, the gate pulse generating unit 22 of the power conversion device 1b generates the gate signal, and outputs such a signal to the power conversion circuitry 12. The power conversion circuitry 12 of the power conversion device 1b supplies the AC power that becomes the reference for the frequency to the electric power system 9 at the reference frequency which is controlled by the gate pulse generating unit 22 and which is 50 Hz.

Accordingly, since the AC power that becomes the reference for the frequency is supplied from the power conversion device 1b that substitutes the power conversion device 1a even if the AC power supply by the power conversion device 1a which becomes the reference for the frequency stops, the power outage in the electric power system 9 can be avoided.

As described above, even if the inverter-based power source 10a that operates in the voltage-source mode stops supplying the power, the frequency of the electric power system 9 is maintained to the frequency range f0±Δf2b by the action of the limiter of the phase detector 31 of the power conversion device 1b of the inverter-based power source 10b, and is controlled to a predetermined value like 48.5 Hz. The AC power that becomes the reference for the frequency is supplied from the power conversion device 1b, and thus the power outage of the electric power system 9 is avoided. The frequency range f0±Δf2c of the limiter of the phase detector 31 of the power conversion device 1c is wider than the frequency range f0±Δf2b set for the power conversion device 1b, and the inverter-based power source 10c provided with the power conversion device 1c can keep operating in the normal grid-connected mode.

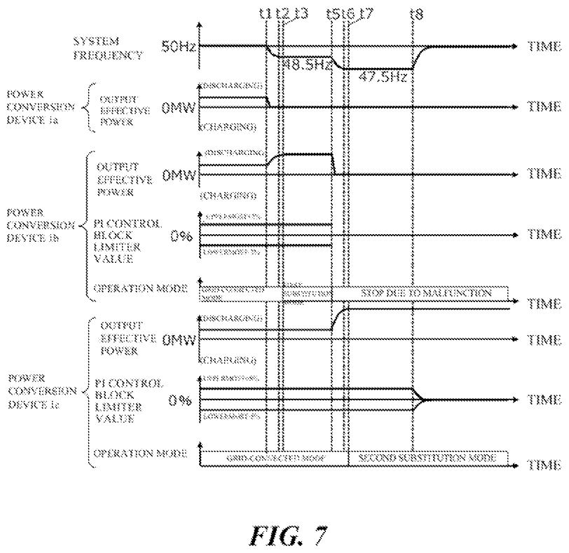

Next, with reference to FIG. 7, a case in which the AC power supply which becomes the reference for the frequency by the power conversion device 1a and by the power conversion device 1b stops will be described.

At the time t1 in a time chart illustrated in FIG. 7, the AC power supply from the inverter-based power source 10a provided with the power conversion device 1b stops. Subsequently, at the time t3, the inverter-based power source 10b provided with the power conversion device 1b starts supplying the AC power which becomes the reference for the frequency and which is 48.5 Hz.

The AC power supply which is 48.5 Hz by the inverter-based power source 10b provided with the power conversion device 1b continues until the time t5. At the time t5, the AC power supply from the inverter-based power source 10b stops due to malfunction, etc. Hence, the AC power supply that becomes the reference for the frequency from the inverter-based power source 10a and also from the inverter-based power source 10b stops.

When the AC power supply from the inverter-based power source 10b stops, the AC power that becomes the reference for the frequency is no longer supplied, and the frequency fm of the electric power system 9 further decreases. Accordingly, the output value of the PI control block 42 of the phase detector 31 of the power conversion device 1c of the inverter-based power source 10c decreases.

At the time t6, the output value of the PI control block 42 of the power conversion device 1c reaches the lowermost frequency f0-Δf2c. The lowermost frequency f0-Δf2c is, for example, 50 Hz −5% (47.5 Hz). The PI control block 42 of the power conversion device 1c limits the frequency to 47.5 Hz that is the preset frequency range f0±Δf2c, and calculates the voltage phase.

At the time t7, the determination block 44 of the power conversion device 1c detects, based on the voltage phase output by the PI control block 42, that the frequency fm of the AC power supplied to the electric power system 9 is not within the preset frequency range f0±Δf1c, and determines that the AC power that becomes the reference for the frequency is not supplied to the electric power system 9. For example, within the frequency range f0±Δf1c is 50 Hz ±3% (47.5 Hz).

Furthermore, based on the fact that the output value of the PI control block 42 reaches the lowermost frequency f0-Δf1c, the determination block 44 of the power conversion device 1c outputs the operation mode information in such a way that the power conversion device 1c transitions to the voltage-source mode from the grid-connected mode and the power conversion circuitry 12 starts outputting the reference AC power. For example, the lowermost frequency f0-Δf1c is 50 Hz −5% (47.5 Hz).

Based on the fact that the operation mode information output by the determination block 44 indicates the voltage-source mode, the selector block 47 outputs the d-axis predetermined value and the q-axis predetermined value to the dq/three-phase conversion block 46. The d-axis predetermined value is set to the rated voltage value of the electric power system 1, and the q-axis predetermined value is set to zero. Moreover, the voltage phase which is 47.5 Hz and output by the phase detector 31 is input to the dq/three-phase conversion block 46.

The dq/three-phase conversion block 46 of the power conversion device 1c outputs, to the gate pulse generating unit 22, the voltage waveform converted into three-phase based on the d-axis predetermined value and the q-axis predetermined value both output by the selector block 47, and on the voltage phase output by the phase detector 31. The voltage waveform converted into three-phase corresponds to the control signal.

Based on the voltage amplitude, frequency and phase according to the voltage waveform that is the control signal received from the output-voltage control unit 21, the gate pulse generating unit 22 of the power conversion device 1c generates the gate signal, and outputs such a signal to the power conversion circuitry 12. In accordance with the amplitude, frequency and phase of the voltage controlled by the gate pulse generating unit 22, the power conversion circuitry 12 of the power conversion device 1c converts the DC power output by the power source 15 into AC power, and supplies such power to the electric power system 9.

By the above-described operations, the power conversion device 1c of the inverter-based power source 10c starts supplying, at the time t7, the AC power that becomes the reference for the frequency to the electric power system 9. The amplitude of the AC power that becomes the reference for the frequency is the rated voltage value of the electric power system 9, and the frequency is 47.5 Hz.

At the time t7, the power conversion device 1c of the inverter-based power source 10c starts supplying the AC power supply which becomes the reference for the frequency, and the AC power of the electric power system 9 becomes 47.5 Hz. At the time t8 after a preset time has elapsed from the time t7, the phase detector 31 of the power conversion device 1c updates the frequency range in the limiter of the PI control block 42 to the value of the frequency according to the reference AC power. The frequency range f0±Δf2c in the limiter of the PI control block 42 is updated to, for example, 50 Hz ±0% from 50 Hz ±5%.

Hence, the output value of the PI control block 42 of the inverter-based power source 10c changes in accordance with the lowermost limiter, and shifts to 50 Hz −0%. Consequently, the phase detector 31 outputs the voltage phase according to the reference frequency that is 50 Hz. Based on the voltage phase according to the reference frequency that is 50 Hz, the gate pulse generating unit 22 of the power conversion device 1c generates the gate signal, and outputs such a signal to the power conversion circuitry 12. The power conversion circuitry 12 of the power conversion device 1c supplies the AC power that becomes the reference for the frequency to the electric power system 9 at the reference frequency which is 50 Hz and which is controlled by the gate pulse generating unit 22.

Hence, even if the AC power supply which becomes the reference for the frequency by the power conversion device 1a and also the power conversion device 1b stops, since the power conversion device 1c that substitutes the power conversion device 1a and the power conversion device 1b supplies the AC power that becomes the reference for the frequency, the power outage in the electric power system 9 can be avoided.

In the above-described example operations, when the AC power supply which becomes the reference for the frequency by the power conversion device 1a and also the power conversion device 1b stops, the frequency according to the power of the electric power system 9 decreases. When, however, the demand-and-supply balance is disrupted due to the operation state of the load 8 in the electric power system 9 and the operation states of the inverter-based power sources 10, such as charging or discharging, and when the AC power supply which becomes the reference for the frequency by the power conversion device 1a and the power conversion device 1b stops, there is a possibility such that the frequency according to the power of the electric power system 9 increases.

In this case, the determination block 44 determines that the AC power that becomes the reference for the frequency is not supplied to the electric power system 9 when the output value of the PI control block 42 reaches the value of the uppermost frequency f0+Δf1c. Moreover, the PI control block 42 limits frequency to the uppermost frequency f0+Δf2 by the limiter, and calculates the voltage phase.

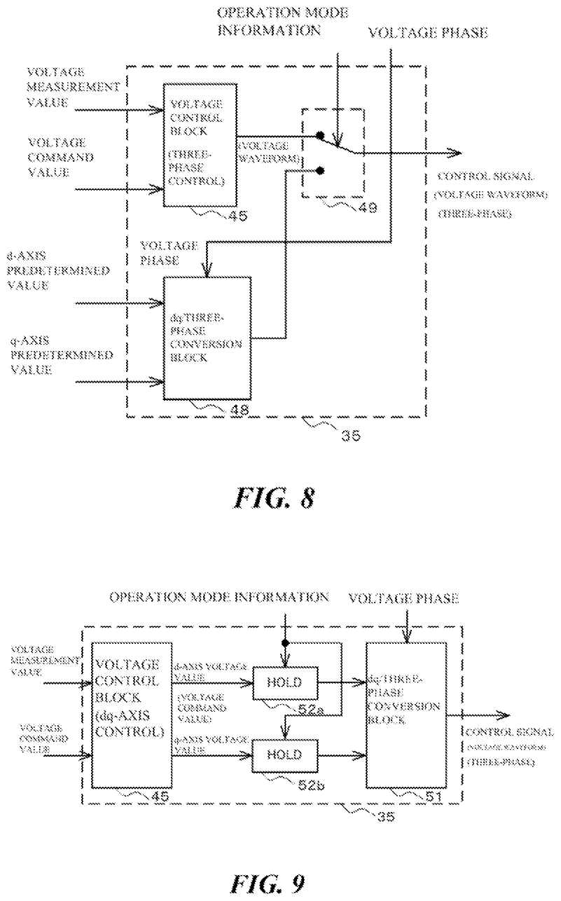

In the above description, the waveform controller 35 has described as employing the structure illustrated in FIG. 5. The waveform controller 35 may employ a structure illustrated in FIG. 8. The waveform controller 35 illustrated in FIG. 8 includes functional blocks that are the voltage control block 45, a dq/three-phase conversion block 48, and a selector block 49.

Although the waveform controller 35 illustrated in FIG. 5 controls the voltage control block 45 on the dq axes, the waveform controller 35 illustrated in FIG. 8 controls the voltage control block 45 in three-phase. The waveform controller 35 illustrated in FIG. 8 outputs a control signal that is a three-phase voltage waveform.

The dq/three-phase conversion block 48 outputs the voltage waveform converted into three-phase based on the d-axis predetermined value, the q-axis predetermined value and the voltage phase of the phase detector 31. The d-axis predetermined value and the q-axis predetermined value may be each a preset fixed value, or may be variables that change over time. For example, the d-axis predetermined value may be set to the rated voltage value of the electric power system 1, and the q-axis predetermined value may be set to zero.

The selector block 49 is connected to the voltage control block 45, the dq/three-phase conversion block 48 and the determination block 44. Input to the selector block 49 are the voltage waveform that is the control signal output by the voltage control block 45 based on the d-axis voltage value and the q-axis voltage value, and on the voltage waveform that is the control signal output by the dq/three-phase conversion block 48 based on the preset d-axis predetermined value and q-axis predetermined value.

The output of the selector block 49 is selected in accordance with the operation mode information output by the determination block 44. When the operation mode information indicates the grid-connected mode, the selector block 49 selects the voltage waveform output by the voltage control block 45, and outputs such a waveform to the gate pulse generating unit 22. When the operation mode information indicates the voltage-source mode, the selector block 49 selects the voltage waveform output by the dq/three-phase conversion block 48, and outputs such a waveform to the gate pulse generating unit 22.

By causing the waveform control controller 35 to employ the structure illustrated in FIG. 8 as described above, the power output by the power source 15 can be converted into the AC power by the power conversion device 1 by three-phase control. When the waveform controller 35 is caused to employ the structure illustrated in FIG. 5, the power output by the power source 15 can be converted into the AC power by the power conversion device 1 by dq-axis control.

Since the AC power that becomes the reference for the frequency can be supplied by the power conversion device 1 even if the AC power supply which becomes the reference for the frequency stops, the power outage in the electric power system 9 can be avoided.

The above is the outline of operation of the power conversion device 1 and that of the power conversion system 100 according to the first embodiment.

(1-3. Advantageous Effects)

(1) According to this embodiment, the power conversion device 1 includes the phase detector 31 that calculates a voltage phase based on the phase of AC power supplied to the electric power system 9, the waveform controller 35 that generates a control signal which designates the frequency and phase of the AC power based on the voltage phase calculated by the phase detector 31, the power conversion circuitry 12 which converts power supplied from the power supply source 15 into the AC power based on the control signal generated by the waveform controller 35, and which outputs the converted power to the electric power system 9, and the determination block 44 which detects the frequency of the AC power supplied to the electric power system 9, and which determines that the AC power that becomes the reference for the frequency is not supplied to the electric power system 9 when the detected frequency is not within a preset first frequency range. When the determination block 44 determines that the AC power that becomes the reference for the frequency is not supplied to the electric power system 9, the waveform controller 35 executes a control on the power conversion circuitry 12 so as to supply the AC power that becomes the reference for the frequency to the electric power system 9. Accordingly, the power conversion device 1 can be provided which can avoid the power outage even if the reference AC power is lost.

The determination block 44 of the power conversion device 1 determines that the AC power that becomes the reference for the frequency is not supplied to the electric power system 9 when the output value of the PI control block 42 is not within a preset frequency range f0±Δf1.

Moreover, the waveform controller 35 executes a control on the power conversion circuitry 12 so as to supply the AC power that becomes the reference for the frequency to the electric power system 9.

(2) According to this embodiment, the phase detector 31 of the power conversion device 1 limits the frequency within a preset second frequency range, and calculates the voltage phase. Hence, the power conversion device 1 can be provided which can output the power limited within the second frequency range even if the reference AC power is lost.

Even if the inverter-based power source 10a that operates in the voltage-source mode stops the power supply, the frequency of the electric power system 9 is maintained within the frequency range f0±Δf2b by the action of the limiter of the phase detector 31 of the power conversion device 1b of the inverter-based power source 10b, and is controlled to a predetermined value like 48.5 Hz. The AC power that becomes the reference for the frequency can be supplied by the power conversion device 1b, and thus the power outage of the electric power system 9 is avoided.

(3) According to this embodiment, the second frequency range f0±Δf2 of the power conversion device 1 is decided based on the preference order of the plurality of power supply sources 15, one of which supplying the AC power that becomes the reference for the frequency to the electric power system 9, and the second frequency range f0±4f2 corresponding to the power supply source 15 with the high preference order is narrower than the second frequency range f0±Δf2 corresponding to the power supply source 15 with a low preference order. Accordingly, the power conversion device 1c connected to the power supply source 15 with the low preference order can maintain the operation in the normal grid-connected mode. Hence, power can be stably supplied to the electric power system 9.

(4) According to the power conversion device 1 of this embodiment, when a preset time has elapsed after the control on the power conversion circuitry 12 so as to supply the AC power that becomes the reference for the frequency to the electric power system 9 starts, the phase detector 31 updates the second frequency range f0±Δf2 to the value f0 of the frequency according to the reference

AC power. Hence, even if the inverter-based power source 10a that operates in the voltage-source mode stops supplying the power, the frequency of the AC power is maintained to the frequency f0 that becomes the reference by the power conversion device 1b that newly operates in the voltage-source mode.

After the preset time has elapsed, the phase detector 31 of the power conversion device 1b updates the frequency range in the limiter of the PI control block 42 to the value of the frequency according to the reference

AC power. The frequency range f0±Δf2b in the limiter of the PI control block 42 is updated to, for example, 50 Hz ±0% from 50Hz ±3%.

Consequently, the phase detector 31 outputs the voltage phase according to the reference frequency that is 50 Hz. Based on the voltage phase according to the reference frequency that is 50 Hz, the gate pulse generating unit 22 of the power conversion device 1b generates the gate signal, and outputs such a signal to the power conversion circuitry 12. The power conversion circuitry 12 of the power conversion device 1b supplies, to the electric power system 9, the AC power that becomes the reference for the frequency at the reference frequency that is 50 Hz under the control of the gate pulse generating unit 22.

(5) According to this embodiment, the waveform controller 35 of the power conversion device 1 includes the selector block 47 that is a changeover unit which selects the first voltage command value (the d-axis voltage value and the q-axis voltage value) or the second voltage command value (the d-axis predetermined value and the q-axis predetermined value). The selector block 47 selects the first voltage command value (the d-axis voltage value and the q-axis voltage value) which is generated based on the voltage phase detected by the phase detector 31 and which designates the frequency and phase of the AC power when the determination block 44 determines that the AC power that becomes the reference for the frequency is supplied to the electric power system 9. The selector block 47 selects the preset second voltage command value (the d-axis predetermined value and the q-axis predetermined value) when the determination block 44 determines that the AC power that becomes the reference for the frequency is not supplied to the electric power system 9. The waveform controller 35 executes the control on the power conversion circuitry 12 in accordance with the first voltage command value (the d-axis voltage value and the q-axis voltage value) or the second voltage command value selected by the selector block 47. Consequently, even if the inverter-based power source 10a that operates in the voltage-source mode stops supplying the power, the reference AC power is supplied to the electric power system 9 at the reference frequency f0 by the power conversion device 1b that newly operates in the voltage-source mode. Hence, the power is stably supplied to the electric power system 9.

(2. Second Embodiment)

(2-1. Structure and Actions)

An example power conversion device 1 according to a second embodiment will be described with reference to FIG. 9. The power conversion device 1 according to the second embodiment includes the waveform controller 35 that employs the following structure. Other structures are the same as those of the power conversion device 1 according to the first embodiment.

The waveform controller 35 of the power conversion device 1 according to the second embodiment includes functional blocks that are the voltage control block 45, a dq/three-phase conversion block 51, and hold blocks 52a and 52b.

The voltage control block 45 is connected to the voltage and current measuring circuitry 13, the current controller 34, and the hold blocks 52a and 52b. Based on the voltage measurement value output by the voltage and current measuring circuitry 13 and on the voltage command value calculated by the current controller 34, the voltage control block 45 calculates the d-axis voltage value and the q-axis voltage value as a new voltage command value, and outputs such values to the hold blocks 52a and 52b, respectively. The d-axis voltage value is a voltage command value relating to the d-axis, and the q-axis voltage value is a voltage command value relating to the q-axis. The voltage control block 45 generates the voltage command value on the dq axis.

The hold blocks 52a and 52b each include a sample-and-hold circuit or a memory circuit. The hold blocks 52a and 52b are connected to the voltage control block 45, the dq/three-phase conversion block 51, and the determination block 44. Input to the hold blocks 52a and 52b are the d-axis voltage value and the q-axis voltage value, respectively, which are output by the voltage control block 45. The hold blocks 52a and 52b have respective hold timings controlled in accordance with the operation mode information output by the determination block 44.

The hold blocks 52a and 52b output the d-axis voltage value and the q-axis voltage value, respectively, both output by the voltage control block 45 to the dq/three-phase conversion block 51 without holding those values when the operation mode information indicates the grid-connected mode. When the operation mode indicated by the operation mode information changes from the grid-connected mode to the voltage-source mode, the hold blocks 52a and 52b hold the d-axis voltage value and the q-axis voltage value, respectively, both output by the voltage control block 45 several 10 milliseconds before a timing at which the operation mode indicated by the operation mode information changes from the grid-connected mode to the voltage-source mode, and outputs such values to the dq/three-phase conversion block 51.

The second voltage command value in claims may be the past d-axis voltage value and q-axis voltage value both output by the voltage control block 45 and held by the hold block 52.

The dq/three-phase conversion block 46 outputs the voltage waveform converted into three-phase based on the d-axis voltage value and the q-axis voltage value both output by the hold blocks 52a and 52b and on the voltage phase output by the phase detector 31, and outputs such a waveform to the gate pulse generating unit 22.

According to the power conversion device 1 that includes the waveform controller 35 illustrated in FIG. 5 according to the first embodiment, when the operation mode indicated by the operation mode information changes from the grid-connected mode to the voltage-source mode, the gate pulse generating unit 22 is controlled based on the preset d-axis predetermined value and q-axis predetermined value, and the power is output by the power conversion device 1. For example, the d-axis predetermined value is set to the rated voltage value of the electric power system 1, and the q-axis predetermined value is set to zero.

This is because, with respect to the amplitude of the voltage according to the power that is output by the power conversion device 1 in the voltage-source mode, the system voltage of the electric power system 9 is caused to approximate the rated voltage. When it is recognized that the system voltage of the electric power system 9 should be decreased in advance, the d-axis predetermined value may be set to be lower than the rated voltage value. In accordance with the situation of the electric power system 9 that can be assumed in advance, the d-axis predetermined value is set to be an arbitrary value.

According to the power conversion device 1 of the first embodiment, when, however, the operation mode indicated by the operation mode information changes from the grid-connected mode to the voltage-source mode, there is a possibility such that the voltage according to the power output by the power conversion device 1 keenly changes. This originates from the fact that the selector block 49 keenly selects the d-axis predetermined value and the q-axis predetermined value based on the operation mode information instead of the d-axis voltage value and of the q-axis voltage value. Accordingly, there is a possibility such that the amplitude of the voltage waveform input to the gate pulse generating unit 22 keenly changes.

When the amplitude of the voltage waveform input to the gate pulse generating unit 22 keenly changes, there is a possibility such that the current according to the power output by the power conversion device 1 unintendedly keenly increases, and the system voltage becomes unstable.

Moreover, since the other power conversion device 1 that is operating in the voltage-source mode stops outputting the power, a turbulence occurs, and the system voltage of the electric power system 9 have divergence from the set d-axis predetermined value and q-axis predetermined value.

Accordingly, there is a possibility such that the output current of the power conversion device 1 that newly operates in the voltage-source mode unintendedly keenly increases, and the system voltage becomes unstable. When the other power conversion device 1 that is operating in the voltage-source mode stops outputting the power, it is difficult in some cases to determine in advance what d-axis predetermined value and q-axis predetermined value should be set to the power conversion device 1 that newly operates in the voltage-source mode.

In the case of the power conversion device 1 that includes the waveform controller 35 illustrated in FIG. 9 according to the second embodiment, when the operation mode indicated by the operation mode information changes from the grid-connected mode to the voltage-source mode, the hold blocks 52a and 52b hold the d-axis voltage value and the q-axis voltage value, respectively, both output by the voltage control block 45 in past from the timing at which the operation mode indicated by the operation mode information changes from the grid-connected mode to the voltage-source mode, and outputs such values to the dq/three-phase conversion block 51. Accordingly, the waveform controller 35 generates the voltage waveform based on, for example, the d-axis voltage value and the q-axis voltage value several 10 milliseconds past from the timing at which the operation mode indicated by the operation mode information changes from the grid-connected mode to the voltage-source mode, and outputs such a waveform as the control signal.

That is, the voltage according to the output power by the power conversion device 1 immediately before the other power conversion device 1 that is operating in the voltage-source mode stops outputting the power is maintained. According to the power conversion device 1 of the second embodiment, it is unnecessary to calculate, every time the situation of the electric power system 9 changes, the d-axis voltage value and the q-axis voltage value at the timing at which the operation mode indicated by the operation mode information changes from the grid-connected mode to the voltage-source mode, and to set those values to the power conversion device 1.

Even if the operation mode indicated by the operation mode information changes from the grid-connected mode to the voltage-source mode, the d-axis voltage value and the q-axis voltage value corresponding to a change in the situation of the electric power system 9 are input to the gate pulse generating unit 22. Accordingly, a keen change in the voltage according to the output power by the power conversion device 1 is suppressed, and thus the stable power is supplied to the electric power system 9.

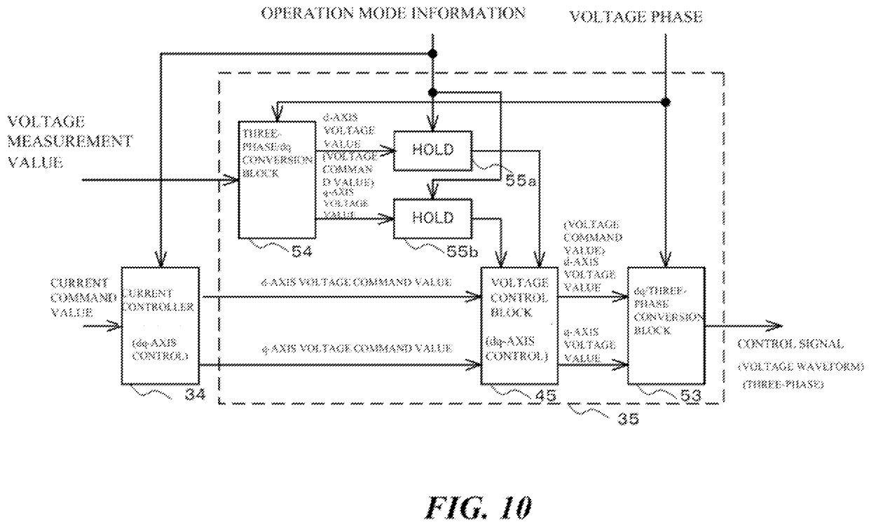

The power conversion device 1 according to the second embodiment may be embodied as having the current controller 34 and the waveform controller 35 employing the structure as illustrated in FIG. 10. Other structures are the same as those of the power conversion device 1 according to the first embodiment. According to the example structure illustrated in FIG. 10, the controls by the current controller 34 and by the waveform controller 35 are executed on the dq axis.

The waveform controller 35 of the power conversion device 1 includes functional blocks that are a three-phase/dq conversion block 54, a voltage control block 45, a dq/three-phase conversion block 53, and hold blocks 55a and 55b.

The three-phase/dq conversion block 54 is connected to the voltage and current measuring circuitry 13, the hold blocks 55a and 55b, and the phase detector 31. Based on the voltage measurement value output by the voltage and current measuring circuitry 13 and on the voltage phase output by the phase detector 31, the three-phase/dq conversion block 54 calculates the d-axis voltage value and the q-axis voltage value as the voltage command value, and outputs those values to the hold blocks 55a and 55b, respectively.

The hold blocks 55a and 55b each include a sample-and-hold circuit or a memory circuit. The hold blocks 55a and 55b are each connected to the three-phase/dq conversion block 54, the voltage control block 45, and the determination block 44. The d-axis voltage value and the q-axis voltage value output by the three-phase/dq conversion block 54 are input to the hold blocks 55a and 55b, respectively. The hold blocks 55a and 55b have the respective hold timings controlled in accordance with the operation mode information output by the determination block 44.

The hold blocks 55a and 55b respectively output, to the voltage control block 45, the d-axis voltage value and the q-axis voltage value output by the three-phase/dq conversion block 54 without holding those values when the operation mode information indicates the grid-connected mode. The hold blocks 55a and 55b hold the d-axis voltage value and the q-axis voltage value that are output by the three-phase/dq conversion block 54 when the operation mode indicated by the operation mode information changes from the grid-connected mode to the voltage-source mode, e.g., several 10 milliseconds before the timing at which the operation mode indicated by the operation mode changes from the grid-connected mode to the voltage-source mode, and output such values to the voltage control block 45.

The current controller 34 is connected to the voltage and current measuring circuitry 13, the power controller 33, and the waveform controller 35. The current controller 34 calculates the d-axis voltage value and the q-axis voltage value as the voltage command value based on the current measurement value output by the voltage and current measuring circuitry 13 and on the current command value calculated by the power controller 33. The d-axis voltage value and the q-axis command value that are the voltage command value are the command values that cause the effective power and the reactive power both output by the power conversion circuitry 12 to follow the desired power value. The current controller 34 outputs the d-axis voltage value and the q-axis voltage value that are the calculated voltage command values to the waveform controller 35. The current controller 34 is connected to the determination block 44, and sets the d-axis voltage value and the q-axis voltage value to zero when a notification to the effect that, the operation mode changes from the grid-connected mode to the voltage-source mode, is given by the operation mode information.

The voltage control block 45 is connected to the hold blocks 55a and 55b, and to the current controller 34. The voltage control block 45 calculates the d-axis voltage value and the q-axis voltage value as the new voltage command value based on the d-axis voltage value and the q-axis voltage value respectively output by the hold blocks 55a and 55b, and the d-axis voltage value and the q-axis voltage value both output by the current controller 34.

For example, the voltage control block 45 adds the d-axis voltage value output by the current controller 34 to the d-axis voltage value output by the hold block 55a so as to calculate the new d-axis voltage value, and adds the q-axis voltage value output by the current controller 34 to the q-axis voltage value held by the hold block 55b so as to calculate the new q-axis voltage value.

The dq/three-phase conversion block 53 outputs, to the gate pulse generating unit 22, the voltage waveform converted into three-phase based on the d-axis voltage value and the q-axis voltage value both output by the voltage control block 45 and on the voltage phase output by the phase detector 31.

Accordingly, even if the operation mode indicated by the operation mode information changes from the grid-connected mode to the voltage-source mode, the voltage waveform in three-phase is input to the gate pulse generating unit 22 as the control signal corresponding to the change in the situation of the electric power system 9. Hence, a keen change in the voltage according to the output power by the power conversion device 1 is suppressed, and thus the stable power is supplied to the electric power system 9.

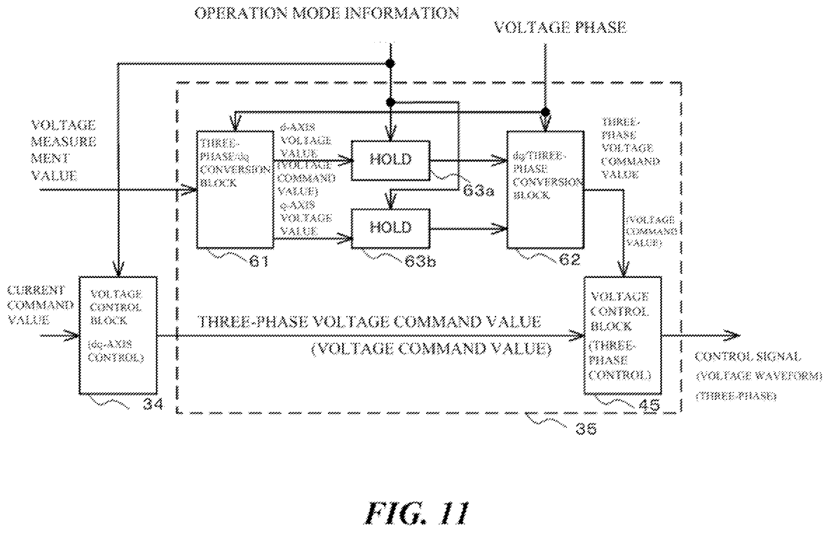

The power conversion device 1 according to the second embodiment may be embodied as having the current controller 34 and the waveform controller 35 employing the structure as illustrated in FIG. 11. Other structures are the same as those of the power conversion device 1 according to the first embodiment. According to the example structure illustrated in FIG. 10, the controls by the current controller 34 and by the waveform controller 35 are executed on the dq axis, but according to the example structure illustrated in FIG. 11, the controls by the current controller 34 and by the waveform controller 35 are executed in three-phase.

The waveform controller 35 of the power conversion device 1 includes functional block that are a three-phase/dq conversion block 61, a dq/three-phase conversion block 62, the voltage control block 45, and hold blocks 63a and 63b.

The three-phase/dq conversion block 61 is connected to the voltage and current measuring circuitry 13, the hold blocks 63a and 63b, and the phase detector 31. Based on the voltage measurement value output by the voltage and current measuring circuitry 13 and on the voltage phase output by the phase detector 31, the three-phase/dq conversion block 61 calculates the d-axis voltage value and the q-axis voltage value as the voltage command value, and outputs these values to the hold blocks 63a and 63b, respectively.

The hold blocks 63a and 63b each include a sample-and-hold circuit or a memory circuit. The hold blocks 63a and 63b are each connected to the three-phase/dq conversion block 61, the dq/three-phase conversion block 62, and the determination block 44. The d-axis voltage value and the q-axis voltage value both output by the three-phase/dq conversion block 61 are input to the hold blocks 63a and 63b, respectively. The hold blocks 63a and 63b have respective hold timings controlled in accordance with the operation mode information output by the determination block 44.

The hold blocks 63a and 63b output, to the dq/three-phase conversion block 62, the d-axis voltage value and the q-axis voltage value, respectively, both output by the three-phase/dq conversion block 61 without holding these values when the operation mode information indicates the grid-connected mode. The hold blocks 63a and 63b holds the d-axis voltage value and the q-axis voltage value, respectively, both output by the three-phase/dq conversion block 61 when the operation mode indicated by the operation mode information changes from the grid-connected mode to the voltage-source mode, e.g., several 10 milliseconds before the timing at which the operation mode indicated by the operation mode information changes from the grid-connected mode to the voltage-source mode, and then outputs such values to the dq/three-phase conversion block 62.

The dq/three-phase conversion block 62 outputs, to the voltage control block 45, the three-phase voltage command value that is the voltage command value converted into three-phase based on the d-axis voltage value and the q-axis voltage value both respectively output by the hold blocks 63a and 63b and on the voltage phase output by the phase detector 31.

The current controller 34 is connected to the voltage and current measuring circuitry 13, the power controller 33, and the voltage control block 45. The current controller 34 calculates the three-phase voltage command value that is the voltage command value converted into three-phase based on the current measurement value output by the voltage and current measuring circuitry 13 and on the current command value calculated by the power controller 33. The three-phase voltage command value includes the voltage waveforms in three-phases. The three-phase voltage command value is set to be a command value that causes the effective power and the reactive power both output by the power conversion circuitry 12 to follow the desired power value. The current controller 34 outputs the calculated three-phase voltage command value to the voltage control block 45 of the waveform controller 35. The current controller 34 is connected to the determination block 44, and sets the d-axis voltage value and the q-axis voltage value to zero when a notification to the effect that, the operation mode changes from the grid-connected mode to the voltage-source mode, is given by the operation mode information.

The voltage control block 45 is connected to the dq/three-phase conversion block 62 and to the current controller 34. The voltage control block 45 calculates the three-phase voltage waveform as the control signal based on the three-phase voltage command value output by the dq/three-phase conversion block 62 and on the three-phase voltage command value output by the current controller 34. For example, the voltage control block 45 adds the three-phase voltage command value output by the current controller 34 to the three-phase voltage command value output by the dq/three-phase conversion block 62 so as to calculate the new three-phase voltage command value, and outputs the three-phase voltage waveform to the gate pulse generating unit 22 as the control signal.

Accordingly, even if the operation mode indicated by the operation mode information changes from the grid-connected mode to the voltage-source mode, the three-phase voltage waveform is input to the gate pulse generating unit 22 as the control signal corresponding to the change in the situation of the electric power system 9. Hence, a keen change in the voltage according to the output power by the power conversion device 1 is suppressed, and the stable power is supplied to the electric power system 9.

The above is the outline of the operation of the power conversion device 1 and that of the power conversion system 100 according to the second embodiment.

(2-2. Advantageous Effects)

(1) The power conversion device 1 according to this embodiment includes the hold block 52 that holds the past voltage command value which is generated previously by a predetermined time based on the voltage phase detected by the phase detector 31 and which designates the frequency and phase of the AC power, and the first voltage command value is the past voltage command value held by the hold block 52. Hence, a keen change in the voltage according to the output power by the power conversion device 1 is suppressed, and thus the stable power is supplied to the electric power system 9.

Moreover, according to the power conversion device 1 of this embodiment, it is unnecessary to calculate the d-axis voltage value and the q-axis voltage value at the timing at which the operation mode indicated by the operation mode information changes from the grid-connected mode to the voltage-source mode every time the situation of the electric power system 9 changes, and to set such calculated values to the power conversion device 1.

(3. Other Embodiments)

Although the embodiments including the modified examples have been described, those embodiments are merely presented as examples, and are not intended to limit the scope and spirit of the present disclosure. These embodiments can be carried out in various forms, and various omissions, replacements and changes can be made thereto without departing from the scope and spirit of the present disclosure. Such embodiments and the modified examples thereof fall within the scope and spirit of the present disclosure, and also fall within the scope and spirit of the invention as recited in claims and within the equivalent range thereof. The followings are the examples thereof.

(1) According to the above-described embodiments, in the power conversion system 100, the three inverter-based power sources 10 are connected to the electric power system 9, but the number of the inverter-based power sources 10 connected to the electric power system 9 is not limited to this number. The number of the inverter-based power sources 10 connected to the electric power system 9 may be two, or equal to or greater than four. Moreover, power generation facilities, such as thermal power generation, hydroelectric power generation, and nuclear power generation, may be connected to the electric power system 9.

(2) According to the above-described embodiments, although the power source 15 for the inverter-based power source 10 is a renewable energy power source, such as a solar power generation facility or a wind power generation facility, the power source 15 is not limited to these types. The power source 15 may be a fuel cell or an apparatus that generates power by geothermal power generation.

### REFERENCE SIGNS LIST

1 Power conversion device

8 Load

9 Electric power system

10 Inverter-based power source

12 Power conversion circuitry

13 Voltage and current measuring circuitry

14 Control circuitry

15 Power source

21 Output-voltage control unit

22 Gate pulse generating unit

31 Phase detector

32 Power calculator

33 Power controller

34 Current controller

35 Waveform controller

41, 54, 61 Three-phase/dq conversion block

42 PI control block

43 Integration block

44 Determination block

45 Voltage control block

46, 48, 51, 53, 62 Dq/three-phase conversion block

47, 49 Selector block

52a, 52b, 55a, 55b, 63a, 63b Hold block

100 Power conversion system

1. A power conversion device comprising:
a phase detector that calculates a voltage phase based on a phase of AC power supplied to an electric power system;
a waveform controller that generates a control signal which designates a frequency of the AC power and a phase thereof based on the voltage phase calculated by the phase detector;
a power conversion circuitry which converts power supplied from a power supply source into the AC power based on the control signal generated by the waveform controller, and which outputs the converted power to the electric power system; and
a determination block which detects the frequency of the AC power supplied to the electric power system, and which determines that the AC power that becomes a reference for the frequency is not supplied to the electric power system when the detected frequency is not within a preset first frequency range,
wherein when the determination block determines that the AC power that becomes the reference for the frequency is not supplied to the electric power system, the waveform controller executes a control on the power conversion circuitry so as to supply the AC power that becomes the reference for the frequency to the electric power system.

2. The power conversion device according to claim 1, wherein the phase detector limits the frequency within a preset second frequency range, and calculates the voltage phase.

3. The power conversion device according to claim 2, wherein:
the second frequency range is decided based on a preference order of a plurality of the power supply sources, one of which supplying the AC power that becomes the reference for the frequency to the electric power system; and
the second frequency range corresponding to the power supply source with a high preference order is narrower than the second frequency range corresponding to the power supply source with a low preference order.

4. The power conversion device according to claim 3, wherein when a preset time has elapsed after the control on the power conversion circuitry so as to supply the AC power that becomes the reference for the frequency to the electric power system starts, the phase detector updates the second frequency range to a value of the frequency according to the reference AC power.

5. The power conversion device according to claim 1, wherein:
the waveform controller includes a changeover unit that selects a first voltage command value or a second voltage command value;
the changeover unit selects the first voltage command value which is generated based on the voltage phase detected by the phase detector and which designates the frequency and phase of the AC power when the determination block determines that the AC power that becomes the reference for the frequency is supplied to the electric power system;
the changeover unit selects the preset second voltage command value when the determination block determines that the AC power that becomes the reference for the frequency is not supplied to the electric power system; and
the waveform controller executes the control on the power conversion circuitry in accordance with the first voltage command value or the second voltage command value selected by the changeover unit.

6. The power conversion device according to claim 5, further comprising a hold block that holds a past voltage command value which is generated previously by a predetermined time based on the voltage phase detected by the phase detector and which designates the frequency and phase of the AC power,
wherein the second voltage command value is the past voltage command value held by the hold block.

7. The power conversion device according to claim 2, wherein:
the waveform controller includes a changeover unit that selects a first voltage command value or a second voltage command value;
the changeover unit selects the first voltage command value which is generated based on the voltage phase detected by the phase detector and which designates the frequency and phase of the AC power when the determination block determines that the AC power that becomes the reference for the frequency is supplied to the electric power system;
the changeover unit selects the preset second voltage command value when the determination block determines that the AC power that becomes the reference for the frequency is not supplied to the electric power system; and
the waveform controller executes the control on the power conversion circuitry in accordance with the first voltage command value or the second voltage command value selected by the changeover unit.

8. The power conversion device according to claim 7, further comprising a hold block that holds a past voltage command value which is generated previously by a predetermined time based on the voltage phase detected by the phase detector and which designates the frequency and phase of the AC power,
wherein the second voltage command value is the past voltage command value held by the hold block.

9. The power conversion device according to claim 3, wherein:
the waveform controller includes a changeover unit that selects a first voltage command value or a second voltage command value;
the changeover unit selects the first voltage command value which is generated based on the voltage phase detected by the phase detector and which designates the frequency and phase of the AC power when the determination block determines that the AC power that becomes the reference for the frequency is supplied to the electric power system;
the changeover unit selects the preset second voltage command value when the determination block determines that the AC power that becomes the reference for the frequency is not supplied to the electric power system; and
the waveform controller executes the control on the power conversion circuitry in accordance with the first voltage command value or the second voltage command value selected by the changeover unit.

10. The power conversion device according to claim 9, further comprising a hold block that holds a past voltage command value which is generated previously by a predetermined time based on the voltage phase detected by the phase detector and which designates the frequency and phase of the AC power,
wherein the second voltage command value is the past voltage command value held by the hold block.

11. The power conversion device according to claim 4, wherein:
the waveform controller includes a changeover unit that selects a first voltage command value or a second voltage command value;
the changeover unit selects the first voltage command value which is generated based on the voltage phase detected by the phase detector and which designates the frequency and phase of the AC power when the determination block determines that the AC power that becomes the reference for the frequency is supplied to the electric power system;
the changeover unit selects the preset second voltage command value when the determination block determines that the AC power that becomes the reference for the frequency is not supplied to the electric power system; and
the waveform controller executes the control on the power conversion circuitry in accordance with the first voltage command value or the second voltage command value selected by the changeover unit.

12. The power conversion device according to claim 11, further comprising a hold block that holds a past voltage command value which is generated previously by a predetermined time based on the voltage phase detected by the phase detector and which designates the frequency and phase of the AC power,
wherein the second voltage command value is the past voltage command value held by the hold block.
